(19) United States
(12) Patent Application Publication
(10) Pub. No.: US 2023/0395841 A1
(43) Pub. Date: Dec. 7, 2023

(54) BATTERY CELLS INCLUDING LITHIUM-ION CONDUCTING SOLID ELECTROLYTES AND METHODS OF MAKING THEREOF

(71) Applicant: NEXTECH BATTERIES, INC., Carson City, NV (US)

(72) Inventors: JOHN CHMIOLA, Carson City, NV (US); Zachary Favors, Carson City, NV (US); Fabio Albano, Carson City, NV (US); Bill Burger, Carson City, NV (US)

(73) Assignee: NEXTECH BATTERIES, INC., Carson City, NV (US)

(21) Appl. No.: 18/247,640

(22) PCT Filed: Oct. 4, 2021
(86) PCT No.: PCT/US2021/053381

§ 371 Date: Apr. 1, 2023

Related U.S. Application Data
(60) Provisional application No. 63/087,169, filed on Oct. 2, 2020.

(51) Int. Cl. H01M 10/0525; H01M 10/0562; H01M 4/04; H01M 4/58

(52) U.S. Cl. CPC H01M 10/0525; H01M 10/0562; H01M 4/0435; H01M 4/5815; H01M 4/405

(57) ABSTRACT

A solid-state battery comprising at least one electrode stack that includes a solid-state electrolyte, cathode, and optionally an anode. The electrolyte can be an oxygen-free and carbon-free solid-state and alkali-conducting electrolyte that is processable in oxygen-containing atmospheres with room temperature ionic conductivity greater than 1 mS/cm and room temperature shear modulus greater between 1 GPa and 20 GPa. The cathode can be composed of an electrochemically-active material from Group 16 of the periodic table having a high surface area greater than 10 m2/g and contact with a conductive carbon material. The anode can be comprised of any material that can reversibly accommodate group 1 or group 2 elements or the base group 1 or group 2 element. The solid-state battery can utilize a solid-state electrolyte having a lithium-conducting sulfide electrolyte, of the formula U6PS5X (X=Cl, Br, I) with argyrodite structure and exhibiting ionic conductivity over 1 mS cm-1 at room temperature.

### REFERENCE TO RELATED APPLICATION

This patent application claims priority to U.S. Provisional Application 63/087,169 filed Oct. 2, 2020, the disclosure of which is considered part of the disclosure of this application and is hereby incorporated by reference in its entirety.

### FIELD OF THE INVENTION

This invention relates generally to a rechargeable solid-state battery. In some aspects, the present disclosure relates to a fast lithium-ion conducting solid-state electrolyte and the manufacturing methods to make it at room temperature and in oxygen-containing atmosphere.

### BACKGROUND

The performance of all-solid-state batteries using inorganic solid electrolytes is expected to exceed that of conventional lithium-ion batteries from the viewpoint of safety, energy density, power density, and cycle life.

Due to their high ionic conductivity and superior chemo-mechanical properties for manufacture and operation, sulfide composites have received increasing attention as a solid electrolyte in all-solid-state batteries. Sulfur's smaller binding energy to Li-ions and larger atomic radius than oxygen provide high ionic conductivity and make them attractive for practical applications. In recent years, noticeable efforts have been made to develop high-performance sulfide solid-state electrolytes.

Developing electrochemical storage devices with high energy densities, e.g., superior to 1000 Wh/L, and specific energy superior to 500 Wh/kg, is vitally important for powering our future electric mobility and grid applications. The increasing demand for high energy and high-power energy storage solutions which are safe and economical has become a major driving force for the development of solid-state batteries. The state-of-the-art lithium-ion batteries, e.g., the ones available in a Tesla electric vehicle (EV), based on available organic liquid electrolytes, are more and more recognized as a bottleneck in the effort to develop safe high-performance systems. Particularly the cylindrical cell formats including, 18650, 21700 and the most recent 4680, have been fully maximized in terms of specific energy and energy density.

Instead, inorganic fast ion-conducting solids with high electrochemical stability in contact with the anode (often Li metal) and the cathode material (often Nickel, Cobalt, Manganese Oxides and Sulfur-Carbon composites), favorable mechanical properties, cost-efficient low temperature synthesis, sufficient kinetic stability for operation over a wide temperature window and sufficient thermodynamical stability for operation over a wide voltage window increasingly appear as key components in most of the promising next generation energy storage systems including both all-solid state batteries as well as conversion chemistry (Li-Sulphur, Li-air, Li-redox flow) battery concepts wherein electrode liquids or slurries are combined with solid electrolytes to facilitate scalability in a semi-solid battery system.

In addition to the development of solid electrolytes with high lithium-ion conductivities and decreasing interfacial resistance, the construction and maintenance of solid-solid interfaces have attracted attention to potential battery cell developers. In conventional lithium-ion batteries, the interface between the electrode active material and the electrolyte solution is a solid-liquid interface, whereas all-solid-state batteries have a solid-solid interface.

However, sulfide solid-state electrolytes face numerous challenges including: 1) the need for a higher stability voltage window, 2) a better electrode-electrolyte interface and air stability, and 3) a cost-effective approach for large-scale manufacturing. There exists a need for a comprehensive approach to solve these issues and deliver an all-solid-state battery based on sulfide electrolytes that has extremely high energy density preserving the practical aspects of manufacturing at room temperature and atmosphere.

### BRIEF SUMMARY OF THE INVENTION

In one aspect, this disclosure is related to a bulk-type all-solid-state battery composed of compressed powder electrode/electrolyte layers. Compared to a thin film battery, a bulk-type battery suitable for large-sized energy-storage devices and with higher efficiency in terms of energy and power.

In another aspect, this disclosure is related to a method of manufacturing sulfide solid-state electrolytes compatible with lithium metal and high energy cathode materials in a dry room.

In yet another aspect, the present disclosure is related to a solid-state lithium battery including a solid-state electrolyte having a lithium-conducting sulfide electrolyte, of the formula Li6PS5X (X=Cl, Br, I) with argyrodite structure and exhibiting ionic conductivity over 1 mS cm-1 at room temperature and a wide electrochemical window and moderate mechanical properties.

In yet another aspect, the present disclosure is related to an anode-less solid-state battery. The anode-less battery cell can include a lithium sulfide-based cathode instead of an elemental sulfur cathode. In some exemplary embodiments, the cathode matrix can be comprised of between about 25-95% LixSy (x is 0 to 2 any y is 1 to 8) with the remainder being any suitable conductive additive. This anode-less embodiment can provide lithium from the lithium sulfide cathode for the cell. A solid-state electrolyte containing lithium can provide an additional balance of lithium to the anode-less cell.

In yet another aspect, the present disclosure is related to utilizing a cathode material that lies within the voltage stability window of the electrolyte and/or uses oxidative decomposition advantageously to use this electrochemical decomposition reversibly as battery capacity.

The invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

### BRIEF DESCRIPTION OF THE DRAWINGS

FIG. 1 is a graphical illustration of the charge and discharge curves of an exemplary embodiment of a battery of the present disclosure.

FIG. 2 is an illustration of an exemplary embodiment of a single cell with cathode composite and solid electrolyte in a coin cell package of the present disclosure.

FIG. 3 is an illustration of an exemplary embodiment of a double cell with bipolar electrodes in a coin cells package totaling about >4V nominal voltage.

FIG. 4 is an illustration of an exemplary embodiment of a four cells stack with bipolar electrodes totaling about >8V nominal voltage.

FIG. 5 is a graphical illustration of the charge and discharge curves of a bipolar electrodes cell with two cells as presented in FIG. 4.

FIG. 6 is an illustration of the cold rolling technique used to form an exemplary embodiment of a solid electrolyte of the present disclosure.

FIG. 7A is an image showing a 500 um thick bed of powder argyrodite.

FIG. 7B is an image showing a 75 um thickness argyrodite film after being passed through a cold roller assembly.

FIG. 8 is an illustration of co-rolling technique and assembly for preparing both composite cathode and electrolytes simultaneously.

FIG. 9 is an image of a composite poly(aramid)-argyrodite co-rolled separator

FIG. 10 an electron microscopic image of a solid electrolyte and composite cathode material of the present disclosure.

FIG. 11 is a charge/discharge curve of an exemplary embodiments of an anode-free cell of the present disclosure.

FIG. 12 is an illustration of an exemplary embodiment of an anode-free single cell with cathode composite and solid electrolyte in a coin cell package of the present disclosure.

FIG. 13 is an illustration of an exemplary embodiment of a single cell with cathode composite and solid electrolyte and interface modifier in a coin cell package of the present disclosure.

FIG. 14 is a charge/discharge curve of a battery cell using an interface modifier consisting of 6M LiFSI in DME.

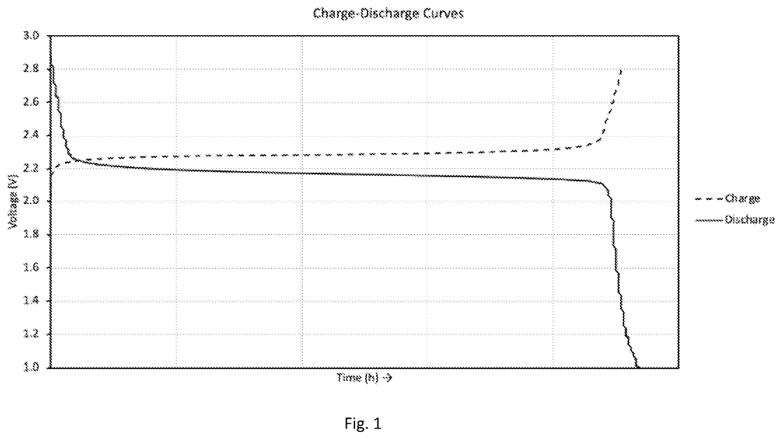

### DETAILED DESCRIPTION OF THE INVENTION

The following detailed description includes references to the accompanying drawings, which forms a part of the detailed description. The drawings show, by way of illustration, specific embodiments in which the invention may be practiced. These embodiments, which are also referred to herein as “examples,” are described in enough detail to enable those skilled in the art to practice the invention. The embodiments may be combined, other embodiments may be utilized, or structural, and logical changes may be made without departing from the scope of the present invention. The following detailed description is, therefore, not to be taken in a limiting sense.

Before the present invention of this disclosure is described in such detail, however, it is to be understood that this invention is not limited to particular variations set forth and may, of course, vary. Various changes may be made to the invention described and equivalents may be substituted without departing from the true spirit and scope of the invention. In addition, many modifications may be made to adapt a particular situation, material, composition of matter, process, process act(s) or step(s), to the objective(s), spirit or scope of the present invention. All such modifications are intended to be within the scope of the disclosure made herein.

Unless otherwise indicated, the words and phrases presented in this document have their ordinary meanings to one of skill in the art. Such ordinary meanings can be obtained by reference to their use in the art and by reference to general and scientific dictionaries.

References in the specification to “one embodiment” indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. The following explanations of certain terms are meant to be illustrative rather than exhaustive. These terms have their ordinary meanings given by usage in the art and in addition include the following explanations.

As used herein, the term “and/or” refers to any one of the items, any combination of the items, or all of the items with which this term is associated.

As used herein, the singular forms “a,” “an,” and “the” include plural reference unless the context clearly dictates otherwise.

As used herein, the terms “include,” “for example,” “such as,” and the like are used illustratively and are not intended to limit the present invention.

As used herein, the terms “preferred” and “preferably” refer to embodiments of the invention that may afford certain benefits, under certain circumstances. However, other embodiments may also be preferred, under the same or other circumstances.

Furthermore, the recitation of one or more preferred embodiments does not imply that other embodiments are not useful and is not intended to exclude other embodiments from the scope of the invention.

As used herein, the term “coupled” means the joining of two members directly or indirectly to one another. Such joining may be stationary in nature or movable in nature. Such joining may be achieved with the two members, or the two members and any additional intermediate members being integrally formed as a single unitary body with one another or with the two members or the two members and any additional intermediate members being attached to one another. Such joining may be permanent in nature or alternatively may be removable or releasable in nature. Similarly, coupled can refer to a two member or elements being in communicatively coupled, wherein the two elements may be electronically, through various means, such as a metallic wire, wireless network, optical fiber, or other medium and methods.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the disclosure.

As used herein, the terms “cathode” and “anode” refer to electrodes of a battery. During a charge cycle in a Li-secondary battery, Li ions leave the cathode and move through an electrolyte and to the anode. During a charge cycle, electrons leave the cathode and move through an external circuit to the anode. During a discharge cycle in a Li-secondary battery, Li ions migrate towards the cathode through an electrolyte and from the anode. During a discharge cycle, electrons leave the anode and move through an external circuit to the cathode.

In some aspects, the present disclosure relates to a sulfide-based all-solid-state batteries with enhanced properties (structural and chemical), manufacturing of sulfide solid-state electrolytes compatible with lithium metal and high energy cathode materials in the dry room, including electrochemical and chemical stability, interface stabilization, and their applications in high performance and safe energy storage.

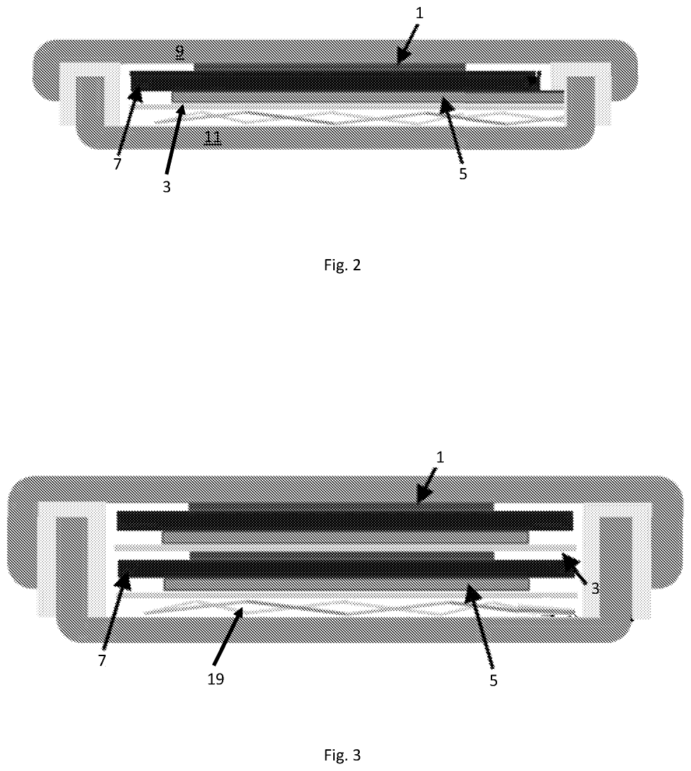

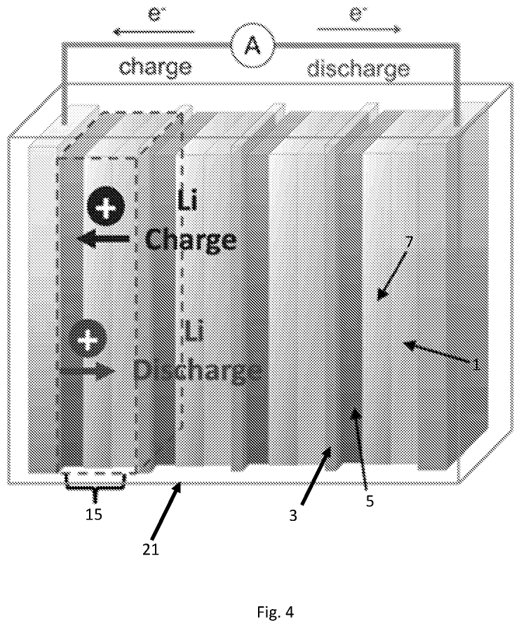

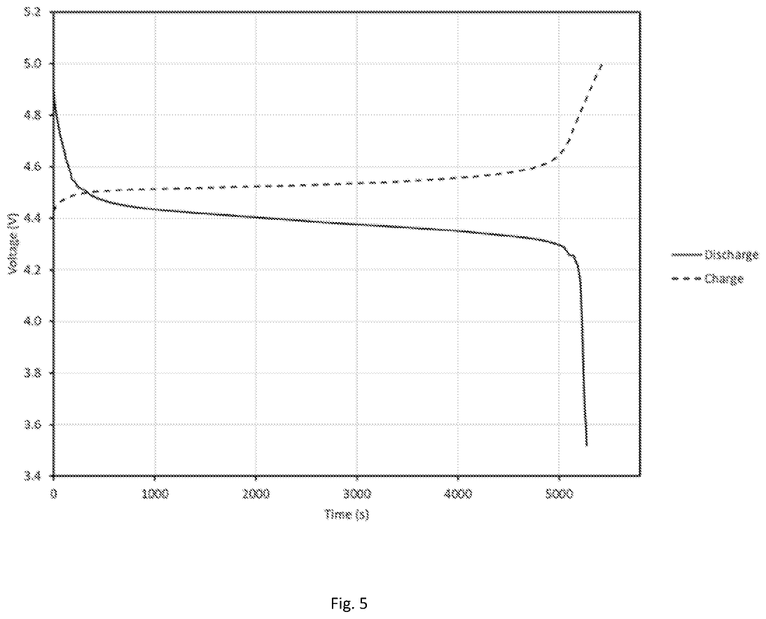

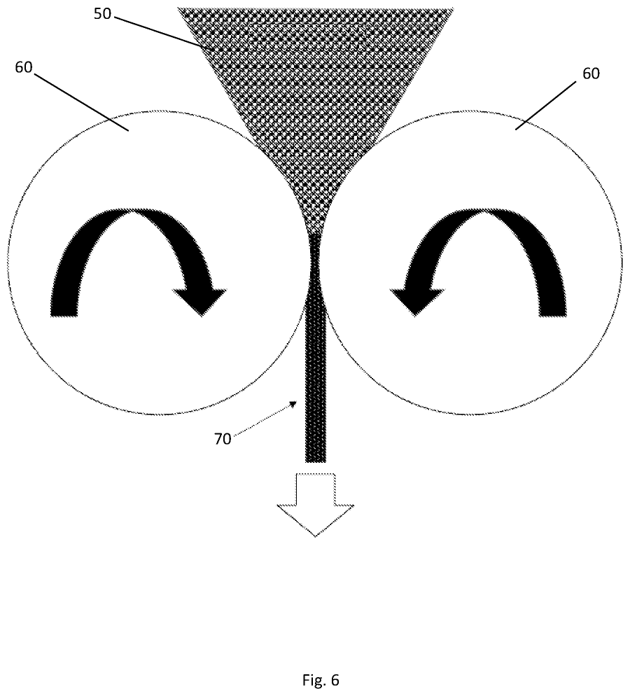

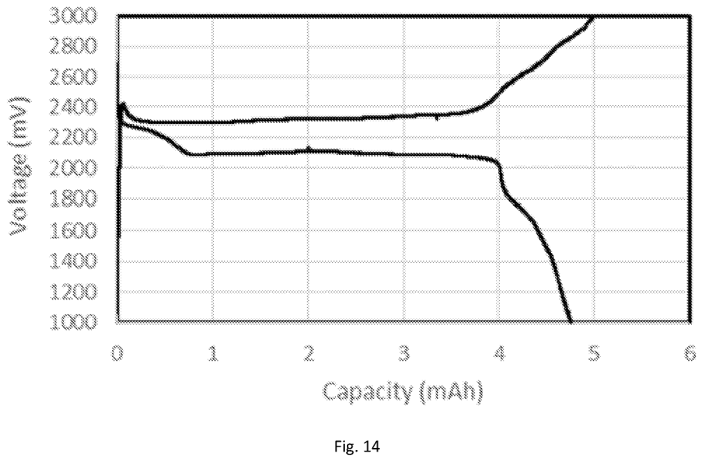

As shown in FIGS. 2-4 & 12-13, some exemplary embodiments of the present disclosure can include a cathode 1, current collector 3, anode 5, and a solid electrolyte 7. The battery cell can take any suitable form including but not limited to classic coin cell batteries, planar stacked pouch cell batteries, or more novel nonplanar batteries that take advantage of the different processing routes and battery mechanical properties that this invention discloses. The battery cell 100 can include a casing and binding means 13. FIGS. 2-4 and 12-13 show a non exhaustive combination of planar forms of exemplary embodiments of solid-state battery cells of the present disclosure. As shown in FIGS. 3-4, the coin cell can have a top casing 9 and a bottom casing 11. Additionally, the cell can include one or more compressive members 19, such as a spring to aid in maintain pressure between the various components within the cell. FIG. 3 provides an illustration of a bipolar solid-state coin cell having at least two layers of a cathode, solid electrolyte and anode, with each layer separated by a current collector 3. In some exemplary embodiments, the current collector can be a metal mesh. In some exemplary embodiments, the lithium metal of the anode can operate as a current collector as shown in FIG. 14. Similarly, the cell can include multiple solid-state units 15 or electrode stack, wherein the units can include a cathode, anode, and solid-state electrolyte as shown in FIG. 4. A package seal 21 can be used between the top casing and bottom casing to seal the coin cell. Additionally, a spring or other compressive member 19 can be utilized to maintain pressure between the components within the cell.

The design of the solid-solid interface can affect the performance of the cell. In some exemplary embodiments of a high-performance composite electrode layer can include the use of highly conducting solid electrolyte materials and high-performing electrode active materials. An active material of the electrode can include any suitable material, including but not limited to sulfur, selenium, tellurium, or any electrically conductive composites of the foregoing, as well as any other suitable elements that are electrochemically active which may be composited with electrically conductive additive. Active materials can further include elements from Group 16 of the periodic table. The active materials can be used for solid-state cathode matrices for use in a solid-state battery cell. In some exemplary embodiments, the selenium and tellurium composites can have higher electronic conductivities and can impart lower impedance on a solid-state battery cell. The active materials can be introduced as elemental powders via any suitable method, including but not limited to dry ball milling with material in powder forms. A mixture of the active materials with the electrically conductive additive can be a homogenous mixture. The active materials can be any suitable materials including but not limited to sulfur, selenium, tellurium, or a combination of each. In some exemplary embodiments, the mixture of active materials from group 16 of the periodic table can comprise between about 1% to about 90%, or between about 10% to about 70%, or between about 20% to about 50% by weight of the cathode matrix. The remainder can be comprised of solid electrolyte and/or other materials that provide function for improving electronic/ionic conductivity, resistance to metal dendrite propagation, improved mechanical properties, and/or simplified processing. In other exemplary embodiments, the amount of active materials of selenium or tellurium can be less than about 5% by weight of the cathode matrix. In some exemplary embodiments, the remaining matrix can be comprised of between about 0-90% sulfur or sulfur composite and 5-95% conductive additive. The conductive additive can include any suitable material including but not limited to graphene, carbon nanotubes, carbon black, sub stoichiometric metal oxides, or other materials. For exemplary embodiments having high energy, cathode active loading can be about 70% or between about 60%-80% by weight, and both carbon and electrolyte can comprise less than about 15% each or between about 10-20% each by weight of the cathode, anode, and electrode components.

For exemplary embodiments having a moderate mix of power and energy, lower active loadings are preferable. Additionally, active materials loadings can be relatively high compared to electrolyte loadings. In some embodiments, the cathode thickness can be between about 10 um and 250 um, with exemplary embodiments having cathode thickness between about 25 um and 75 um. The electrolyte thickness separating the anode and the cathode can have thickness between about 5 um and 500 um, with exemplary embodiments having thickness less than about 25 um. In some exemplary embodiments, the cathode can include a sulfide based catholyte surrounding the cathode active material and enabling current densities above 1 mA/cm2.

Additionally, the interface 17 between the electrolyte and electroactive materials of the cathode can also be designed to include a large contact area between electrode and electrolyte, including a high surface area of active materials in intimate contact with solid electrolytes. Similarly, a low resistance interface between the electrode and solid electrolyte can be used. Furthermore, an effective lithium-ion and electron conduction pathway can be used, such as a percolating network of electronically conductive additives in active materials (e.g., graphene backbone in the graphene-sulfur composite or other active material composite) and be in intimate contact with ionically conductive/electronically insulating solid electrolyte. Increased performance can further be accomplished by reducing damage to electrode active materials during electrode processing/manufacturing utilizing the room temperature sintering process of the present disclosure.

Some exemplary embodiments of the present disclosure can utilize a specialized interface that can increase the interface contacts as close to 100% of the various components of the cell in order to achieve high current density. In one exemplary embodiment, the interface 17 can be an ionic gel or liquid. The ionic gel or liquid can be a material with lower stiffness or fluid, but with high concentration of mobile lithium ions that can similarly act as a secondary phase/interface 17. In another exemplary embodiment, the cathode matrix 1 can be pore-less and 100% solid, with the solid-state electrolyte also being 100% solid with no gaps between the anode, cathode, and electrolyte layer. An exemplary embodiment, of the present disclosure can utilize any suitable solid-state electrolyte 7. In order to account for potential residual porosity of one or more of the electrodes, an ionically conductive medium may be provided to improve contact between discreet particles or layers of the cell. In some embodiments, the electrolyte component can contain a secondary material which is reactive towards metallic alkali metals that retards the progression of metallic alkali growths from the anode to the cathode.

The ionically conductive gel or liquid can include a fluorinated lithium salt, including but not limited to lithium triflate (“LitF”), Lithium bis(trifluoromethane sulfonyl)imide (“LiTFSI”), or Lithium bis(fluorosulfonyl)imide (“LiFSI”). Similarly, the interface can include an ionically conductive gel or liquid that can include a fluorinated ionic liquid that solvates a fluorinated lithium salt, including but not limited to 1-butyl-1-methylpyrrolidinium is(trifluoromethylsulfonyl)imide (“PYR14TFSI”). In some exemplary embodiment, the ionic gel or liquid interface can comprise up to about 20% by weight of the interior cell components, or between about 1% and about 10% by weight, or less than 5% by weight of the interior cell components (cathode, electrolyte, and anode).

In other exemplary embodiments, some glassy ceramic electrolytes, e.g. Li3BO3-Li2SO4, and many sulfide solid electrolytes, e.g. Li2S—P2S5, can be densified by pressing at room temperature, or between about −20° C. to about 600° C. or between about 50° F. and 500° F., or between about 60° F. and 120° F. at pressures between about 1 mPa to about 1000 MPa, or between about 10 MPa to about 750 MPa, or between about 100 MPa to about 500 MPa. Similarly, the room-temperature pressure-sintering can be done without the use of any external heat source. By applying high pressure at or around room temperature, using a uniaxial mechanical press or an equivalent technique that can apply suitable pressure, fully dense electrolyte thick films can be obtained with negligeable or absent grain boundaries. The grain boundary resistance is therefore very low or negligeable imparting superior qualities compared to the equivalent oxide-based materials. The densification mechanism involves the “room-temperature pressure-sintering” phenomenon, i.e., the possibility of manufacture parts that are fully dense and lacking grain boundaries by merely pressing the materials at room temperature to a relative density greater than about 95%. Additionally, in some exemplary embodiments, moderately low temperatures can provide beneficial faster chemical kinetics and add defined porosity.

In some exemplary embodiments, densification of oxide-based ceramics can be used and can require sintering at high temperatures (e.g., 900-1350° C. for Li7La3Zr2O12 (LLZO)). In the “green” body of such typical oxide solid electrolytes, which may be prepared by pressing powders at room temperature, grains with shapes similar to those of the starting material particles can be observed. The “green” body can have a low density and point contacts among grains, which can cause a large boundary resistance and a low ionic conductivity. Most typical oxide-based solid electrolytes, including but not limited to Li7La3Zr2O12 (“LLZO”), do not show pressure-sintering phenomena at room temperature and can only achieve relevant properties and densities after processing at high temperature. In some exemplary embodiments of the present disclosure, it is possible to construct effective solid-solid interfaces at room temperature by applying “room-temperature pressure-sintering” phenomenon.

Among different kinds of sulfide electrolytes, Li6PS5X (X=Cl, Br, I) with argyrodite structure exhibits ionic conductivity over 1 mS cm-1 at room temperature along with a wide electrochemical window and moderate mechanical properties, Li6PS5X is generally synthesized via high-energy ball milling and/or solid-state reaction. Similarly, chlorine-based electrolytes can be utilized in exemplary embodiments of the present disclosure.

Additionally, amorphous electrolytes can be used in the construction of the solid-state battery cell such as those based on glasses including but not limited to Li2S—P2S5, Li2S—P2S5-Li4SiO4, Li2S—SiS2, Li2S—Ga2S3-GeS2, Li2S-Sb2S3-GeS2, Li2S-GeS2-P2S5, Li10GeP2S12, Li10SnP2S12, Li2S—SnS2-As2S5. In some exemplary embodiments, the amorphous electrolytes can be used as interfacial layers or the bulk conducting layer in a hybrid construction utilizing multiple different electrolytes for electrochemical, structural, or processing reasons, but we haven't gotten there yet.

A strong relationship exists between the elastic modulus and the mean (average) atomic volume of solid electrolyte materials. The binding energy per unit volume is related to the interatomic distance and the atoms coordination number, i.e., the higher the atom packing (higher coordination number) and the smaller the mean atomic volume (smaller atoms), the higher is the material Young's modulus. The mean atomic volumes of sulfide can be significantly higher than oxides and Young's moduli of sulfide glasses are generally below about 30 GPa, while the oxides have a greater moduli.

The mean atomic volume of the sulfides can have lower Young's moduli than oxides. The Young's modulus can be controlled to some extent by chemical composition. As the Young's moduli of molded bodies can be greatly affected by porosity, battery design must take the porosities of the components into consideration in addition to the pure elastic moduli of the materials. Furthermore, it is expected that higher battery performance can be achieved by considering the expansion and shrinkage of the electrode active material during charge and discharge. That is, the pressure applied to all-solid-state cells should be determined by considering the expansion rates and elastic moduli of the electrode active materials and the composite electrode, as well as the elastic modulus of the solid electrolyte.

Sulfide-based solid electrolytes are particularly suited to achieve room temperature pressure sintering as they are sufficiently “soft” to flow at room temperature and fully densify. This room-temperature process simplifies battery manufacturing and suppresses side reactions between the electrode and the electrolyte, a problem that plagues oxide-based materials both during processing at high temperatures and operation at room temperature. By understanding and applying the room-temperature pressure-sintering phenomenon, it is possible to construct an effective solid-solid interface which is a major roadblock for all solid-state batteries.

A variety of active materials have been applied to bulk-type all solid-state cells. The active materials can be classified into four categories on the basis of cell potential; (I) lithium transition-metal oxides and phosphates with a potential of 3.5-5 V, (II) sulfur-based materials with 2 V, (Ill) conversion-reaction materials with 1-2 V, and (IV) alloying reaction materials with below 1 V. This invention spans the limits of zones I and II, i.e., cell potential (vs. Li+/Li) above 1.5V.

The battery electrolyte may be selected from any suitable electrolyte, including but not limited to Li2S—P2S5 glass, Li2S—P2S5-Li4SiO4 glass, Li2S—SiS2 glass, Li2S—Ga2S3-GeS2 glass, Li2S—Sb2S3-GeS2 glass, Li2S—GeS2-P2S5 glass, Li10GeP2S12 glass, Li10SnP2S12 glass, Li2S—SnS2-As2S5 glass, Li2S—SnS2-As2S5 glass-ceramic, and argyrodite-type structures containing Group 7 halogens. In some exemplary embodiments, the battery of the present disclosure can include an all-solid-state lithium battery including a solid-state electrolyte having a lithium-conducting sulfide electrolyte, of the formula Li6PS5X (X=Cl, Br, I) with argyrodite structure and exhibiting ionic conductivity over 1 mS cm-1 at room temperature along with a wide electrochemical window and moderate mechanical properties.

Other suitable examples can include the thio-LISICON phase Li3.25Ge0.25P0.75S4 (2.2 mS·cm-1, Ea=0.21 eV); Li10GeP2S12 (12 mS·cm-1, Ea=0.25 eV), and its derivatives, such as Li9.54Si1.74P1.44S11.7Cl0.3 (25 mS·cm-1, Ea=0.24 eV), Li7P3S11 (17 mS·cm-1, Ea=0.18 eV), as well as the Li-argyrodite phases Li6PS5X (X=Cl, Br) (˜1 mS cm-1, Ea=0.3-0.4 eV). Among these, the latter have amongst the best stability in room atmosphere and with respect to lithium metal because an interphase composed of Li2S, Li3P and LiX (X=Cl, Br) forms at a very slow rate in contact with Li that acts as an in situ protective passivating layer.

A solid-state electrolyte can have moderate mechanical properties and a Young's modulus below about 30 GPa for sulfides. Some exemplary embodiments may have a modulus between about 20-30 GPa. In other embodiments, the lithium solid electrolytes can have Young's modulus less than about 10 GPa. Oxides and/or phosphates can be brittle and rigid with Young's modulus greater than 100 MPa, lithium thiophosphates object of the present inventions are softer and much more easily processed and densified, with a Young's modulus less than 10 GPA, more than 10-fold lower than the oxides or phosphates. In some exemplary embodiments, the Young's modulus can be less than 30 GPa or between about 5-30 GPa

Additionally, some exemplary embodiments can include an anode electrode using any suitable material, including but not limited to a lithium metal or composite. The anode electrode can have a thickness from about 1 um to about 500 um or about 20 um to 200 um and can include supporting current densities above about 1 mA/cm2. In some exemplary embodiments the battery may include a sulfide-based catholyte surrounding a cathode active material and enabling current densities above 1 mA/cm2. Some exemplary embodiments, of a battery cell of the present disclosure may have electrode current densities between about 1-4 mA/cm2 or about 1-10 mA/cm2. The cell can be a highly structed 3d cell with substantially thin layers.

Additionally, a cathode active material may comprise an additional intermediate secondary phase/interface modifier 17 that can surround the active material phase. The secondary phase material can be inserted between the electrolyte and the electroactive material to provide improved interfacial contact between the electroactive material and the ionically conductive medium. The intermediate secondary phase can be configured to protect the active material from directly contacting the solid electrolyte and enable ionic conductivities of about 10-3 S cm-1 or higher or reduce charge transfer impedances below 25 Ohm-cm2. In some exemplary embodiment the secondary phase material can contain one or more of the following: a solvent, an alkali-containing salt, and/or a polymer. In some exemplary embodiments, the density of the solid electrolyte can be between about 90-100%, or greater than about 98%. A solid-state electrolyte of the present disclosure can be electrochemically active and participate in the chemical reaction of the battery cell, unlike traditional solid-state electrolytes. In other embodiments, the anode can include one or more of the following components graphite, lithium titanium oxide, silicon, tin, copper, nickel, titanium, gold, platinum, zinc, indium, magnesium, beryllium, carbon, or lithium.

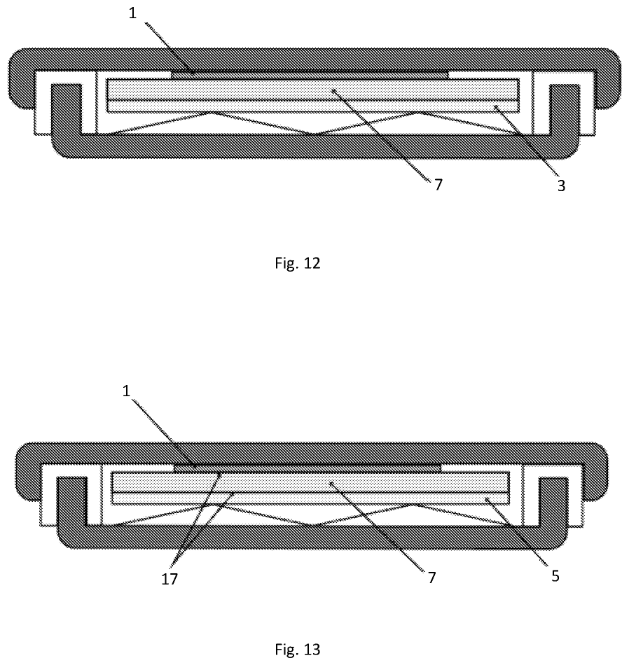

Some exemplary embodiments, of a battery cell of the present disclosure can have an anode-less configuration as shown in FIG. 12. In an anode-less solid-state battery embodiment of the present disclosure, the cell can include a lithium sulfide-based cathode 1 instead of an elemental sulfur cathode. In some exemplary embodiments, the cathode matrix can be comprised of between about 25-95% LixSy (x is 0 to 2 any y is 1 to 8) with the remainder being any suitable conductive additive. This anode-less embodiment can provide lithium from the lithium sulfide cathode for the cell. The electrolyte 7 can provide an additional balance of lithium to the anode-less cell. In some exemplary embodiments, the electrolyte can include an argyrodite. In other exemplary embodiments, the electrolyte 7 can include binders, fillers, oxide nanoparticles, and/or inactive scaffolds among other elements. Additionally, unlike traditional solid-state cells that are assembled in a charged state, the anode-less cell can be assembled in the discharged state. In one exemplary embodiment, a lithium sulfide material, such as Li2S can be introduced as a powder and dry mixed with a conductive agent and a solid-state electrolyte, including but not limited to argyrodite. A current collector can further be included in an anode-less solid-state battery embodiments as shown in FIG. 12.

In some exemplary embodiment, the cathode can include a combination of any of the following components including between about 2% to 98% argyrodite by weight or between about 20% to about 60% argyrodite by weight, and about 2% to about 80% conductive additive, or between about 10% to about 50% conductive additive, and between about 0% to about 80% Li2S, or between about 30% to about 60% Li2S, and between about 0% to about 10% binder, and between about 0% to about 10% lubricant or filler. In some exemplary embodiments, the conductive additive can include but not limited to carbon nanotubes, carbon nanofiber, fullerenes, nano diamond, carbon black, activated carbon, glassy carbon, hard carbon, graphite, or graphene. The mixture can be used to form a cathode matrix for use with a battery cell of the present disclosure. In some exemplary embodiments, the cathode matrix of an anode-less cell described above can be plated or laminated on a metallic foil. The metallic foil can be any suitable material, including, but not limited to nickel, copper, nickel-coated copper, stainless steel, among others.

In some exemplary embodiment, the solid-state electrolyte layer 7 can be formed by room temperature pressure sintering. The solid-state electrolyte may be formed in a manner to include no grain boundaries and no pores. In some embodiments, the solid-state electrolyte, the anode, and/or the cathode can include a coating applied before room temperature pressure sintering.

The solid-state battery of the present disclosure may include a volumetric energy density is between about 100 Wh/L and about 2500 Wh/L, or about 550 Wh/L and about 1500 Wh/L. Furthermore, the battery may have a gravimetric energy density is between about 100 Wh/kg and about 1200 Wh/kg, or about 300 Wh/kg and about 650 Wh/kg. The solid-state Lithium battery of the present disclosure may also include electrodes have a bipolar or pseudo-bipolar design imparting the cell a voltage above about 4V as shown in FIG. 4.

Additionally, in some exemplary embodiments solid state electrodes of the present disclosure may be formed through extrusion. The extrusion method of manufacturing can utilize a binder for the electrode mixture to be extruded. In some exemplary embodiments, the binder can be any suitable material, including but not limited to polyvinylpyrrolidone, Polyvinylidene fluoride, Polytetrafluoroethylene, lithium-substituted polyarcylic acid, polyacrylic acid, among others. The polymer can be ionically conductive or non-conductive for the cathode and solid-state electrolyte layers.

In some exemplary embodiments, the extrusion method of manufacturing can utilize a lubricant for the electrode mixture to be extruded. The lubricant can be any suitable material, including but not limited to paraffin wax, aluminum stearate, butyl stearate, lithium stearate, magnesium stearate, sodium stearate, stearic acid, zinc stearate, oleic acid, poly glycols, talc, graphene oxide and boron nitride. In some exemplary embodiments, the cathode and solid-state electrolyte layers can be formed using a dry mixing process to form a homogenous cathode or electrolyte mixture. These mixing processes can be either batch or continuous. One method of batch try mixing can utilize ball milling. Additional applicable batch mixers include but are not limited to drum blenders, V blenders, bin blenders, ribbon blenders, double-shaft paddle mixers, twin-screw blenders, jet mixers, or any other suitable mixer.

An exemplary embodiment of a cathode mixture can contain one or more of the following: an active material, a conductive agent, solid-state electrolyte, a lubricant and a binder, which are mixed prior to extrusion. In some exemplary embodiments, the concentration of binder is between about 0% to about 10%, or about 1% to about 5%, or about 0.5% to about 3% by weight of the cathode mixture. In some exemplary embodiments, the amount of lubricant is about 0% to about 10%, or about 0.1% to about 2% by weight. In some exemplary embodiments, the amount of active materials of selenium or tellurium can be less than about 5% by weight of the cathode matrix. For exemplary embodiments having high energy, cathode active loading can be about 70% or between about 60%-80% by weight, and both carbon and electrolyte comprise less than about 15% each or between about 10-20% each by weight.

The cathode mixture can then be extruded to form a free-standing, and flexible or rigid film. The film can then cut into cathodes and electrolyte layers, which can be stacked and pressed to form a solid-state cell. Cutting can be accomplished using techniques including but not limited to laser cutting, die cutting, solvent jet cutting, or any other suitable cutting technique. In some exemplary embodiments, lithium can be cut and pressed onto the solid electrolyte opposing the cathode. in the most exemplary embodiment, the process can be carried out in regular oxygen-containing environment with reduced water content.

Additionally, solid state electrodes of the present disclosure may be formed through a rolling method. The rolling method of manufacturing can utilize a binder and/or a lubricant for the electrode mixture to be extruded. In some exemplary embodiments, the binder can be any suitable material, including but not limited to polyvinylpyrrolidone, polyvinylidene fluoride, polytetrafluoroethylene, lithium-substituted polyarcylic acid, polyacrylic acid, among others. The polymer can be ionically conductive or non-conductive for the cathode and solid-state electrolyte layers. In some exemplary embodiments, the rolling method of manufacturing can utilize a lubricant for the electrode mixture to be extruded. The lubricant can be any suitable material, including but not limited to paraffin wax, aluminum stearate, butyl stearate, lithium stearate, magnesium stearate, sodium stearate, stearic acid, zinc stearate, oleic acid, poly glycols, talc, graphene oxide and boron nitride. In some exemplary embodiments, the cathode and solid-state electrolyte layers can be formed using a dry mixing process to form a homogenous cathode or electrolyte mixture and rolled.

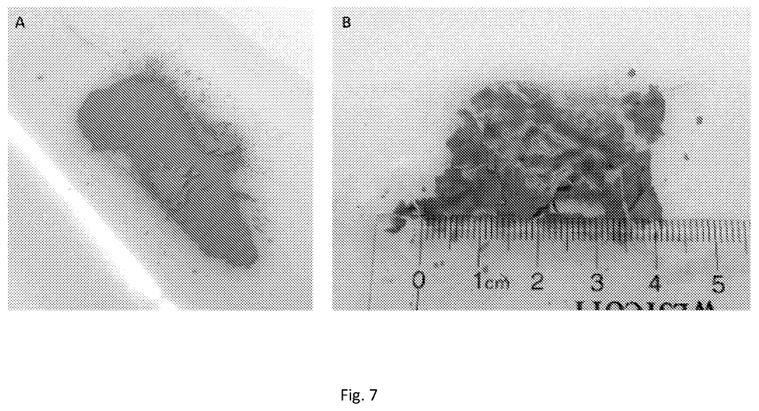

FIG. 7A shows a 500 um thick bed of argyrodite powder on a silica-coated mylar film. FIG. 7B shows a cold sintered 75 um thickness film from that powder bed after passing through two compaction rollers. The mixing processes can be either batch or continuous mixing with one exemplary method of batch dry mixing can utilize ball milling. Additional applicable batch mixers include but are not limited to drum blenders, V blenders, bin blenders, ribbon blenders, double-shaft paddle mixers, twin-screw blenders, jet mixers, and any other suitable mixer. A cathode mixture can contain one or more of an active material, a conductive agent, solid-state electrolyte, a lubricant and a binder, which are mixed prior to extrusion. In some exemplary embodiments, the concentration of binder is between about 0% to about 10%, or about 1% to about 5%, or about 0.5% to about 3%. In some exemplary embodiments, the concentration of lubricant is about 0% to about 10%, or about 0.1% to about 2%.

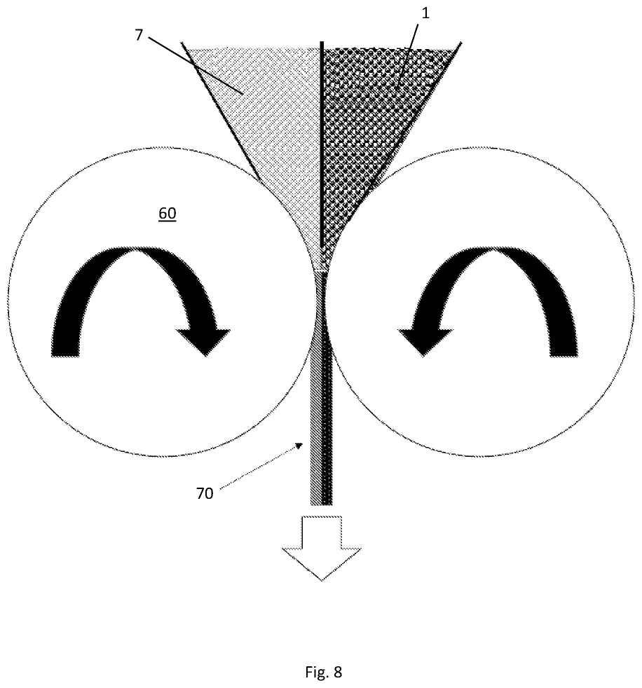

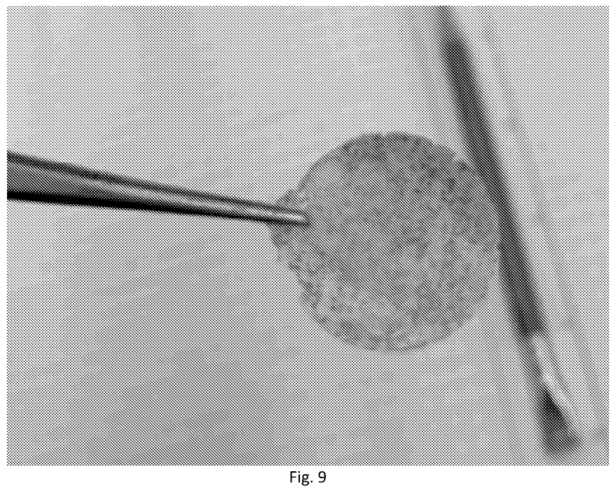

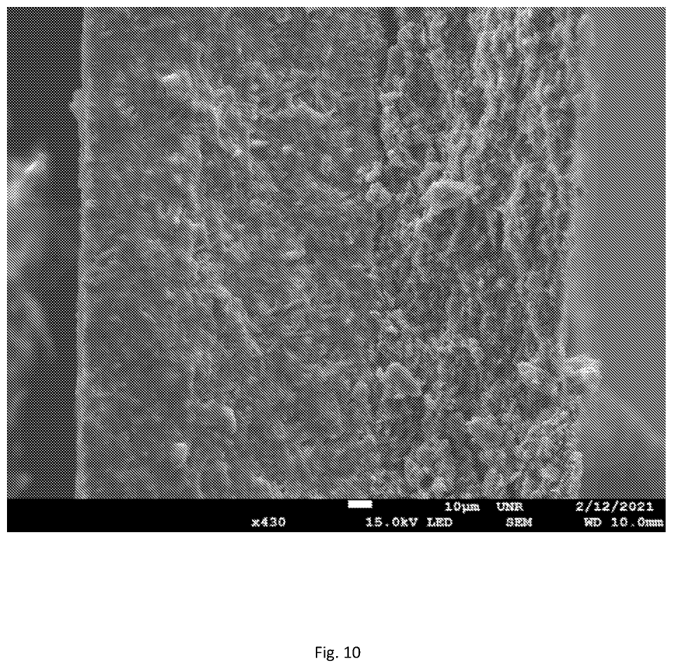

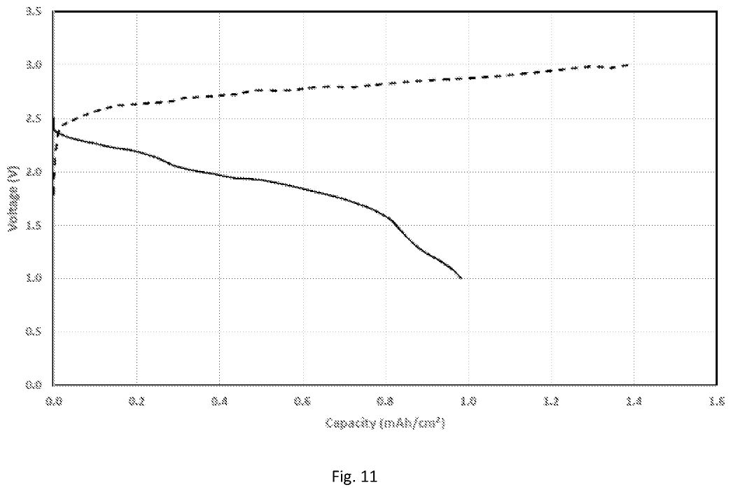

The cathode mixture can then be rolled to form a free-standing, and flexible or rigid film as shown in FIG. 7B. A composite electrode and an electrolyte film can be co-rolled as shown in FIG. 8 using a hopper 50 containing the composite material that is fed between one or more rollers 60. The film 70 can then cut into cathodes and electrolyte layers as shown in FIG. 9, which can be stacked and pressed to form a solid-state cell. In some exemplary embodiments, lithium can be cut and pressed onto the solid electrolyte opposing the cathode. The co-rolling process can be carried out in regular oxygen-containing environment with reduced water content. FIG. 10 further provides an electron microscopic image of a solid electrolyte 7 (left) and composite cathode material 1 (right) of the present disclosure using the room temperature sintering.

In some exemplary embodiments, the disclosure can provide for a solid-state battery that includes an oxygen-free and carbon-free solid-state and alkali-conducting electrolyte that is processable in oxygen-containing atmospheres with room temperature between about 60° F. to about 80° F. ionic conductivity greater than about 5 mS/cm and room temperature shear modulus greater between about 1 GPa and 20 GPa. The solid-state electrolyte can be processed from a powder with particle size less than about 0.5 mm to final form at a temperature below about 50° C. and using pressure between about 200 MPa and 500 MPa resulting in porosity less than about 1%.

The solid-state battery can include a chalcogen-containing cathode that can further include an electrochemically active material from Group 16 of the periodic table having intimate and high surface area greater than about 10 m2/g normalized to the chalcogen and in contact with a conductive carbon material with bulk electrical conductivity greater than about 1 S/cm. In some embodiments, the majority of carbon-chalcogen contact is perpendicular to the sp2 bonds of the carbon. In some exemplary embodiments, the conductive carbon material can be selected from any suitable material including graphene, carbon black, carbon nanotubes, graphite, or other carbon material. The battery cell can further include and an oxygen-free and carbon-free solid-state and alkali-conducting electrolyte having room-temperature ionic conductivity greater than 5 mS/cm and room temperature shear modulus greater than 20 GPa. In some exemplary embodiments, the solid-state battery can further include an anode electrode that is comprised from an alkali metal with a thickness less than about 1000 um. In anode-free embodiments, a metallic substrate such as a current collector, can be present to electrochemically reduce alkali ions transported to it from the cathode forming an anode-free cell. The electrolyte of the battery can be comprised of a lithium-containing and conducting argyrodite having general chemical formula of Li6PS5X, where X is F, Cl, Br, I or their mixtures and combinations. In one exemplary embodiment, the electrolyte component can be Li6PS5Cl.

The battery cell can further include an anode that can be comprised of any suitable material that can reversibly accommodate group 1 or group 2 elements or the base group 1 or group 2 element. Additionally, the anode substrate can be selected from at least on of the following, including but not limited to copper, nickel, titanium, gold, platinum, zinc, indium, magnesium, beryllium, carbon. In some exemplary embodiments, the anode can include or be comprised of an alkali metal with thickness less than 1000 um. This can further include instances where only a metallic substrate is present to electrochemically reduce alkali ions transported to it from the cathode. Similarly, in some exemplary embodiments the alkali metal can be lithium and the chalcogen can be comprised of sulfur, lithium, or a combination of both.

The various components of the solid-state battery including but not limited to the anode, cathode, electrolyte, and any interlayers can be comprised of no oxygen containing compounds. Additionally, in some exemplary embodiments no polymeric compounds are present in the cathode, electrolyte or anode. The electrochemically active cathode chalcogen can further be comprised of a reduced alkali-containing chalcogen compound. In some embodiments the processing of the battery cell from final powder to finished from can be done at atmospheric pressure and/or without the utilization of solvents. Each one of the battery cell units/electrode stacks can be connected in a series to provide a cell voltage that is scalar multiple of the single-cell voltage.

In some embodiments, an all-solid state lithium battery based on argyrodite can be constructed wherein the electrolyte, cathode, anode or any combination of the three is processed by dissolving the argyrodite in ethanol and a porous polymer can be dip coated into the solution. Following the dip coating, the construct can be dried and then compressed to heal any grain boundaries and/or porosity, and heat treated to produce the proper electrolyte phase. A secondary phase can then be included between the anode and electrolyte, cathode and electrolyte or both to improve charge transfer impedance, accommodate active material geometry changes over their lifetime, reduce the pressure needed to ensure functionality or some combination of all.

In some exemplary embodiments, the solid-state battery can include at least one electrode stack that includes a solid-state electrolyte, cathode, and anode. In some other exemplary embodiments, the electrode stack can include only a cathode, electrolyte, and current collector. The electrolyte can be an oxygen-free and carbon-free solid-state and alkali-conducting electrolyte that is processable in oxygen-containing atmospheres with room temperature ionic conductivity greater than 1 mS/cm and room temperature shear modulus greater between 1 GPa and 50 GPa. The cathode can be composed of an electrochemically active material from Group 16 of the periodic table having a high surface area greater than 10 m2/g and contact with a conductive carbon material. The anode can be comprised of any material that can reversibly accommodate group 1 or group 2 elements or the base group 1 or group 2 element. The solid-state battery can utilize a solid-state electrolyte having a lithium-conducting sulfide electrolyte, of the formula Li6PS5X (X=Cl, Br, I) with argyrodite structure and exhibiting ionic conductivity over 1 mS cm-1 at room temperature.

While the invention has been described above in terms of specific embodiments, it is to be understood that the invention is not limited to these disclosed embodiments. Upon reading the teachings of this disclosure many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings.

What is claimed is:

1. A solid-state battery comprising:
an electrode stack comprising:
a solid-state electrolyte comprising:
an oxygen-free and carbon-free solid-state and alkali-conducting electrolyte that is processable in oxygen-containing atmospheres with room temperature ionic conductivity greater than 1 mS/cm and room temperature shear modulus greater between 1 GPa and GPa; and
a cathode comprising:
a conductive carbon material and electrochemically active material from Group 16 of the periodic table having surface area greater than 10 m2/g and contact with the conductive carbon material.

2. The solid-state battery of claim 1 further comprising:
an anode comprising any material that can reversibly accommodate group 1 or group 2, the base group 1 or group 2 element, or assembled in device in the discharged state, only a current collector to serve as a host to reduce group 1 or 2 elements on its surface during first and subsequent charges.

3. The solid-state battery of claim 1, wherein the electrolyte is an alkali-containing argyrodite having general chemical formula of A6PS5X, where A is selected from one of the following: Li, Na, K, Rb, or Cs or their combinations, and X is selected from one of the following: F, Cl, Br, I or At, or their combinations.

4. The solid-state battery of claim 1, wherein the electrolyte is Li6PS5Cl.

5. The solid-state battery of claim 2, wherein an anode substrate of the anode is includes one or more of the following: copper, nickel, titanium, gold, platinum, zinc, indium, magnesium, beryllium, or carbon.

6. The solid-state battery of claim 3, wherein the alkali metal is lithium.

7. The solid-state battery of claim 6, wherein the electrochemically active material is comprised of one or more of the following: sulfur or lithium.

8. The solid-state battery of claim 2, wherein there are no oxygen-containing compounds in the anode, cathode, electrolyte or any interlayers.

9. The solid-state battery of claim 7, wherein the electrochemically active material is a reduced alkali-containing chalcogen compound.

10. The solid-state battery of claim 1, wherein the solid-state electrolyte is processed from powder with particle size less than 0.5 mm to final form at a temperature below 50° C. and using pressure between 200 MPa and 500 MPa resulting in porosity less than 1%.

11. The solid-state battery of claim 2, wherein there are no polymeric compounds in the cathode, solid-state electrolyte, or anode.

12. The solid-state battery of claim 2, wherein there are no solvents in the cathode, electrolyte, or anode.

13. The solid-state battery of claim 10, wherein there are no solvents used in the processing of the battery.

14. The solid-state battery of claim 1, comprising a plurality of electrode stacks connected in series within the battery to provide a cell voltage that is a scalar multiple of the single-cell voltage.

15. The solid-state battery of claim 1, wherein a secondary phase is positioned between the solid-state electrolyte and the cathode containing electroactive materials to improve the interfacial contact between the electroactive material of the cathode and the secondary phase.

16. The solid-state battery of claim 15, wherein the secondary phase contains one or more of the following: a solvent, polymer, or an alkali-containing salt.

17. The solid-state battery of claim 4, wherein the cathode is comprised of between 25-95% LixSy, wherein x is 0 to 2 any y is 1 to 8 by weight.

18. The solid-state battery of claim 1, wherein the electrolyte is also an electrochemically active material.

19. The solid-state battery of claim 1, wherein the conductive carbon material is selected from the sp2 bond-rich group of, graphene, carbon black, carbon nanotubes, or graphite.

20. The solid-state battery of claim 2, wherein the solid-state electrolyte contains a secondary material which is reactive towards metallic alkali metals that retards the progression of metallic alkali growths from the anode to the cathode.
